(19) United States
(12) Patent Application Publication
(10) Pub. No.: US 2025/0102836 A1
(43) Pub. Date: Mar. 27, 2025

(54) SMART LENS COMPOSITION AND SMART LENS MANUFACTURED USING SAME

(71) Applicant: OPTHROTH INC., Gyeonggi-do (KR)

(72) Inventors: HYO JIN JEONG, Gyeonggi-do (KR); SI YOUL YOO, Gyeonggi-do (KR); SAE YOUNG LIM, Gyeonggi-do (KR); HAE YOUNG KIM, Seoul (KR)

(21) Appl. No.: 18/720,827

(22) PCT Filed: Dec. 7, 2022
(86) PCT No.: PCT/KR2022/019801

§ 371 Date: Dec. 13, 2024

(30) Foreign Application Priority Data
Dec. 17, 2021 (KR) 10-2021-0182197
Dec. 1, 2022 (KR) 10-2022-0165803

(51) Int. Cl. G02C 11/00; C08L 83/06

(52) U.S. Cl. CPC G02C 11/10; C08L 83/06; C08L 2205/025

(57) ABSTRACT

A smart lens compositions according to an embodiment includes a non-expandable module and a monomer blend containing a monofunctional silicone monomer and a bifunctional silicone monomer. A smart lens may be manufactured using the above-described smart lens composition. The expansion and distortion of the lens may be suppressed when hydrating the smart lens, and structural stability and uniformity of the smart lens may be improved.

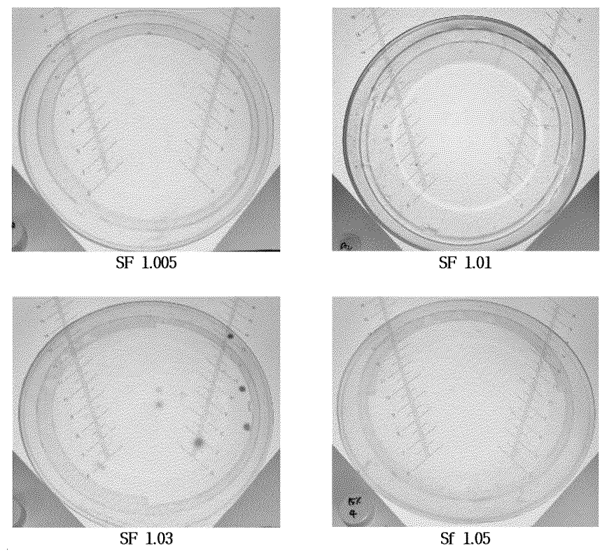

### CROSS REFERENCE TO RELATED APPLICATIONS AND CLAIM OF PRIORITY

This application claims benefit under 35 U.S.C. 119, 120, 121, or 365 (c), and is a National Stage entry from International Application No. PCT/KR2022/019801 filed on Dec. 7, 2022, which claims priority to the benefit of Korean Patent Application Nos. 10-2021-0182197 filed on Dec. 17, 2021 and 10-2022-0165803 filed on Dec. 1, 2022 in the Korean Intellectual Property Office, the entire contents of which are incorporated herein by reference.

### BACKGROUND

### 1. Technical Field

The present invention relates to a lens composition and a lens manufactured using the same. More specifically, the present invention relates to a smart lens composition including an electronic module and a smart lens manufactured using the smart lens composition.

### 2. Background Art

Research on smart wearable devices, in which smart devices are made small and light to be mounted on the body thus to improve convenience, is being actively carried out.

With the development of an e-health system, various electronic devices are being developed to diagnose and treat diseases of a human, and the use of lenses (such as a contact lens) is increasing. For example, the lens may include a lens assembly having an electronically adjustable focus to improve performing abilities of an eye. In addition, the lens may include an electronic sensor to detect the concentration of a certain chemical in the precorneal membrane. Further, the lens assembly may be embedded with electronic devices for communication, power supply, re-energy supply and the like.

In addition, the lens needs to be provided with a communication capability with the embedded electronic device for the purpose of control or data collection. Such communication should be performed without a direct physical connection to the lens electronic device in order to completely seal the electronic device and facilitate communication while the lens is in use. To this end, it is preferable to wirelessly couple signals to the lens electronic device using electromagnetic waves. Accordingly, there is a need to provide an antenna structure suitable for use in the lens.

Embedding the electronic device and providing communication capability to the lens may require technical challenges in a variety of regions. For example, it is necessary to consider the limited sizes (e.g., maximum length, width, and thickness) of components, the limited energy storage capacity of a battery or supercapacitor, the limited peak current consumption due to a high battery internal resistance in a small battery, the limited charge storage capacity of a small capacitor, the limited average power consumption due to the limited energy storage, and the limited robustness and manufacturability of components due to the small size.

### SUMMARY

An object of the present invention is to provide a smart lens composition which provides improved stability and mechanical properties.

Another object of the present invention is to provide a smart lens having improved stability and mechanical properties.

According to an aspect of the present invention, there is provided a smart lens composition including: a non-expandable module; and a monomer blend. The monomer blend may include a monofunctional silicone monomer and a bifunctional silicone monomer.

According to exemplary embodiments, a content of the monofunctional silicone monomer may be higher than a content of the bifunctional silicone monomer.

According to exemplary embodiments, the monofunctional silicone monomer may include a first monofunctional monomer represented by Formula 1 below.

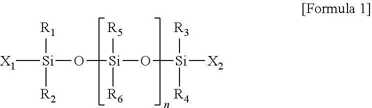

In Formula 1 above, R₁, R₂, R₃ and R₄ are each independently hydrogen or an alkyl group having 1 to 3 carbon atoms, R₅ and R₆ are each independently an alkyl group having 1 to 3 carbon atoms, and n is an integer from 2 to 100.

X₁ is an alkyl group having 1 to 5 carbon atoms, an alkenyl group having 1 to 5 carbon atoms, or an alkynyl group having 1 to 5 carbon atoms, and X₂ is a substituent represented by Formula 2 below.

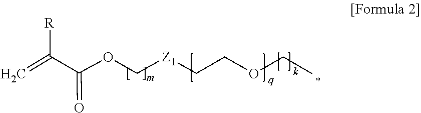

In Formula 2, R₇ is hydrogen or a methyl group, Z₁ is one selected from —NHCOO—, —NHCONH—, —OCONH—R₈—NHCOO—, —NHCONH—R₉—NHCONH— and —OCONH—R₁₀—NHCONH—, and R₈, R₉ and R₁₀ are each an alkylene group having 1 to 5 carbon atoms.

m is an integer from 1 to 5, q is 0 or an integer from 1 to 5, k is an integer from 1 to 10, and * is a bond.

According to exemplary embodiments, n may be 14 in Formula 1.

According to exemplary embodiments, the monofunctional silicone monomer may further include a second monofunctional monomer represented by Formula 3 below.

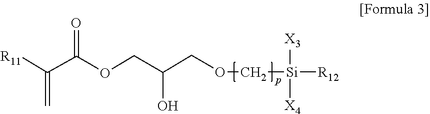

In Formula 3, Ru is hydrogen or a methyl group, R₁₂ is hydrogen or an alkyl group having 1 to 5 carbon atoms, and p is an integer from 1 to 5.

X₃ and X₄ are each independently a substituent of Formula 4 below.

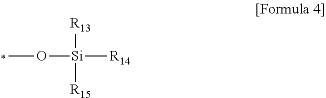

In Formula 4, R₁₃, R₁₄ and R₁₅ are each independently hydrogen or an alkyl group having 1 to 3 carbon atoms, and * is a bond.

According to exemplary embodiments, a ratio of a content of the second monofunctional monomer to a content of the first monofunctional monomer may be 0.5 to 2.

According to exemplary embodiments, the content of the first monofunctional monomer may be higher than the content of the second monofunctional monomer.

According to exemplary embodiments, the bifunctional silicone monomer may include a first bifunctional monomer represented by Formula 5 below.

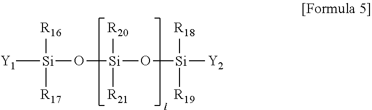

In Formula 5, R₁₆, R₁₇, R₁₈ and R₁₉ are each independently hydrogen or an alkyl group having 1 to 3 carbon atoms, R₂₀ and R₂₁ are each independently an alkyl group having 1 to 3 carbon atoms, and 1 is an integer from 2 to 100.

Y₁ and Y₂ are each independently a substituent represented by Formula 6 below.

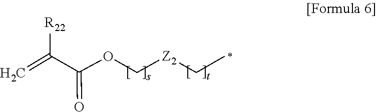

In Formula 6, R₂₂ is hydrogen or a methyl group, Z₂ is one selected from —NHCOO—, —NHCONH—, —OCONH—R₂₃—NHCOO—, —NHCONH—R₂₄—NHCONH— and —OCONH—R₂₅—NHCONH—, and R₂₃, R₂₄ and R₂₅ are each an alkylene group having 1 to 5 carbon atoms.

S is an integer from 1 to 5, t is an integer from 1 to 10, and * is a bond.

According to exemplary embodiments, l may be 14 in Formula 5.

According to exemplary embodiments, an atomic ratio (Si/C) of silicon atoms to carbon atoms in the first bifunctional monomer may be 3 to 4.

According to exemplary embodiments, the bifunctional silicone monomer may further include a second bifunctional monomer represented by Formula 7 below.

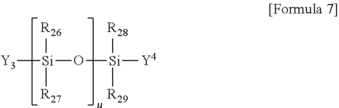

In Formula 7, R₂₆, R₂₇, R₂₈ and R₂₉ are each independently hydrogen or an alkyl group having 1 to 3 carbon atoms, and u is an integer from 1 to 100, and Y₃ and Y₄ are each independently a substituent represented by Formula 8 below.

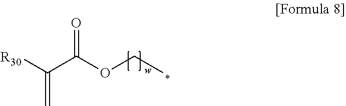

In Formula 8, R₃₀ is hydrogen or a methyl group, w is an alkylene group of 1 to 5, and * is a bond.

According to exemplary embodiments, a content of the first bifunctional monomer may be greater than or equal to a content of the second bifunctional monomer.

According to exemplary embodiments, a ratio of the content of the monofunctional silicone monomer to the content of the bifunctional silicone monomer may be 5 to 10.

According to exemplary embodiments, the monomer blend may further include at least one of a hydrophilic monomer, a UV blocker, an initiator and a cross-linker.

According to exemplary embodiments, a total content of the monofunctional silicone monomer and the bifunctional silicone monomer may be 50 to 95% by weight based on a total weight of the monomer blend.

According to exemplary embodiments, the content of the monofunctional silicone monomer may be 30 to 85% by weight based on the total weight of the monomer blend, and the content of the bifunctional silicone monomer may be 5 to 15% by weight based on the total weight of the monomer blend.

According to exemplary embodiments, the monomer blend may have a viscosity of 38 to 40 cP at room temperature (25° C.).

According to exemplary embodiments, the non-expandable module may include at least one element selected from the group consisting of a sensor, an antenna, a chip, a thin film battery, a thin film camera and a drug release device.

According to another aspect of the present invention, there is provided a smart lens formed from the above-described smart lens composition.

According to exemplary embodiments, the smart lens may have a swelling factor of 1.0 to 1.05. The swelling factor may be calculated by Equation 1 below.

$$Swelling factor = Dw / Dd \qquad [ Equation 1 ]$$

In Equation 1, Dd is a diameter of a lens obtained by polymerizing the smart lens composition, and Dw is a diameter of the lens measured in a state where the obtained lens is completely hydrated.

According to exemplary embodiments, the swelling factor may be 1.0 to 1.02.

The smart lens composition according to exemplary embodiments includes the blend containing a monofunctional silicone monomer and a bifunctional silicone monomer. Accordingly, the structural stability of the smart lens may be improved, and the function of a module included in the smart lens may be maintained stably.

For example, if indention or distortion occurs due to a local difference in expansion within the contact lens, the lens may not be completely attached to the cornea of the eye when worn on the eye. In this case, an empty space may be formed between the lens and the eye, thereby obstructing the wearer's view, and a radius of curvature of the lens may be distorted, thereby affecting the power of the lens and the function of the module.

The monomer blend according to exemplary embodiments may suppress expansion of the lens which may occur when hydrating the smart lens. Accordingly, the expansion between the polymer and the non-expandable module of the above-described monomer blend may be appropriately controlled, and the indention and distortion of the lens due to a local difference in the expansion rate may be prevented.

### BRIEF DESCRIPTION OF THE DRAWING

FIGURE is photographs illustrating shapes of smart contact lenses manufactured according to some embodiments.

### DETAILED DESCRIPTION

The smart lens composition according to embodiments of the present invention may include a non-expandable module and a monomer blend. The monomer blend may include silicone monomers.

In addition, a smart lens manufactured using the smart lens composition may be provided. For example, the smart lens may be used as a smart contact lens.

Hereinafter, embodiments of the present invention will be described in detail. If there is an isomer of a compound or resin represented by formula as used herein, the compound or resin represented by the formula refers to the representative formula including the isomer.

### <Smart Lens Composition>

According to exemplary embodiments, the monomer blend may include a monofunctional silicone monomer and a bifunctional silicone monomer.

For example, the monofunctional silicone monomer may refer to a silicone monomer including only one polymerizable functional group. For example, the bifunctional silicone monomer may refer to a silicone monomer including two polymerizable functional groups.

As the monomer blend includes the bifunctional silicone monomer, the polymerizability and reactivity of the monomer blend may be improved. For example, the bifunctional silicone monomer may function as a linker while providing a high density of cross-linked point in the monomer blend. Therefore, the cross-link density of the lens may be improved, and the mechanical properties and durability thereof may be enhanced.

In addition, as the monomer blend includes the monofunctional silicone monomer, overpolymerization of the monomer blend and distortion of the lens resulting therefrom may be prevented, and the expansion of the polymer may be reduced. Therefore, a lens having a uniform shape may be manufactured, and deterioration in the mechanical properties and stability due to excessive cross-linking and expansion may be prevented.

According to exemplary embodiments, the monofunctional silicone monomer may include a first monofunctional monomer represented by Formula 1 below.

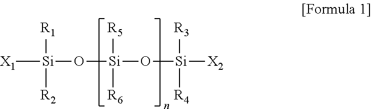

In Formula 1 above, R₁, R₂, R₃ and R₄ may be each independently hydrogen or an alkyl group having 1 to 3 carbon atoms.

R₅ and R₆ may be each independently an alkyl group having 1 to 3 carbon atoms. Preferably, R₁, R₂, R₃, R₄, R₅ and R₆ may be a methyl group, respectively. In this case, the affinity for a hydrophilic material may be increased, such that the compatibility of the monomer blend may be improved and the lenses may be easily manufactured. In addition, the hydrophilicity of the lens may be appropriately controlled to improve the moisture resistance and chemical stability of the lens.

X₁ may be an aliphatic hydrocarbon group having 1 to 5 carbon atoms. For example, X₁ may be an alkyl group having 1 to 5 carbon atoms, an alkenyl group having 1 to 5 carbon atoms, or an alkynyl group having 1 to 5 carbon atoms. Preferably, X₁ is an alkyl group having 1 to 5 carbon atoms, and more preferably an alkyl group having 2 to 4 carbon atoms.

n may be an integer of 2 to 100, preferably 2 to 20, and more preferably 10 to 20. In one embodiment, in Formula 1 above, n may be 14.

Within the above range, as the first monofunctional monomer includes a long polysiloxane unit in the main chain, a degree of expansion of the lens upon hydration may be reduced. The term “main chain” as used herein refers to a portion consisting of the longest chain of atoms in the molecular structure.

X₂ may be a substituent represented by Formula 2 below.

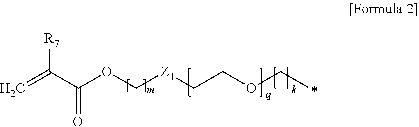

In Formula 2 above, * is a bond, and may be a site binding to silicon (Si) in Formula 1. R₇ may be hydrogen or a methyl group.

Z₁ may be one selected from —NHCOO—, —NHCONH—, —OCONH—R₈—NHCOO—, —NHCONH—R₉—NHCONH— and —OCONH—R₁₀—NHCONH—, and R₈, R₉ and R₁₀ may be an alkylene group having 1 to 5 carbon atoms, respectively.

m may be an integer from 1 to 5, and preferably an integer from 2 to 4. k may be an integer from 1 to 10, and preferably an integer from 2 to 5.

q may be 0 or an integer from 1 to 5, and preferably an integer from 1 to 3. Within the above range, the elasticity and flexibility of the polymer of the monomer blend may be improved, and the structural/mechanical stabilities of the lens may be enhanced.

According to exemplary embodiments, the monofunctional silicone monomer may further include a second monofunctional monomer represented by Formula 3 below.

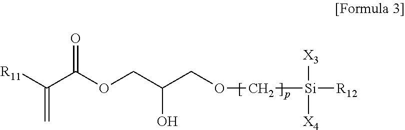

In Formula 3 above, R₁₁ may be hydrogen or a methyl group. R₁₂ may be hydrogen or an alkyl group having 1 to 5 carbon atoms, and preferably a methyl group.

p may be an integer from 1 to 5, and preferably an integer from 2 to 4.

X₃ and X₄ may be each independently a substituent of Formula 4 below.

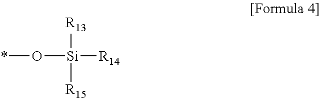

In Formula 4 above, * is a bond.

R₁₃, R₁₄ and R₁₅ may be each independently hydrogen or an alkyl group having 1 to 3 carbon atoms, and preferably a methyl group.

The expansion of the lens due to hydration may be suppressed by the first monofunctional monomer. In addition, the affinity and compatibility of the silicone monomer with the hydrophilic material may be improved by the second monofunctional monomer, and high dispersibility and low viscosity may be provided in the composition.

In some embodiments, a ratio of a content of the second monofunctional monomer to a content of the first monofunctional monomer may be 0.5 to 2, or 0.8 to 2.0, or 0.9 to 1.8. Within the above range, the mechanical properties and chemical stability of the lens may be improved together.

In one embodiment, the content of the first monofunctional monomer may be higher than the content of the second monofunctional monomer. For example, the ratio of the content of the second monofunctional monomer to the content of the first monofunctional monomer may be greater than 1. As the content of the first monofunctional monomer is relatively high, a local difference in expansion of the lens may be suppressed, and the shape and structure thereof may be stably maintained even if the lens is exposed to high temperature and humid environments for a long period of time.

According to exemplary embodiments, the bifunctional silicone monomer may include a first bifunctional monomer represented by Formula 5 below.

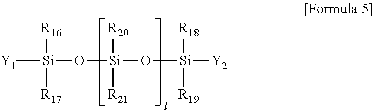

In Formula 5 above, R₁₆, R₁₇, R₁₈ and R₁₉ may be each independently hydrogen or an alkyl group having 1 to 3 carbon atoms.

R₂₀ and R₂₁ may be each independently an alkyl group having 1 to 3 carbon atoms. Preferably, R₁₆, R₁₇, R₁₈, R₁₉, R₂₀ and R₂₁ are a methyl group, respectively. In this case, the chemical resistance may be enhanced while improving the mechanical properties of the lens.

l may be an integer of 2 to 100, preferably 2 to 20, and more preferably 10 to 20. In one embodiment, in Formula 5 above, l may be 14. Within the above range, the length of the polysiloxane unit in the main chain may be appropriately controlled, such that a lens having strength, elasticity and expansion within the desired range may be manufactured and implemented.

Y₁ and Y₂ may be each independently a substituent represented by Formula 6 below.

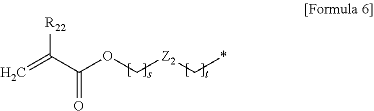

In Formula 6 above, * is a bond, and may be a site binding to silicon (Si) in Formula 5. R₂₂ may be hydrogen or a methyl group.

Z₂ may be one selected from —NHCOO—, —NHCONH—, —OCONH—R₂₃—NHCOO—, —NHCONH—R₂₄—NHCONH—, and —OCONH—R₂₅—NHCONH—. R₂₃, R₂₄ and R₂₅ may be an alkylene group having 1 to 5 carbon atoms, respectively.

S may be an integer from 1 to 5, and preferably an integer from 2 to 4. t may be an integer from 1 to 10, and preferably an integer from 2 to 5. Within the above range, the mechanical properties of the lens may be improved.

In some embodiments, an atomic ratio (Si/C) of silicon atoms to carbon atoms in the first bifunctional monomer may be 3 to 4. Within the above range, the expansion and distortion of the lens due to hydration may be prevented without deterioration in the degree of cross-linking and polymerization of the monomer blend. Preferably, the atomic ratio (Si/C) of silicon atoms to carbon atoms in the first bifunctional monomer may be 3.2 to 3.8, 3.3 to 3.5, and most preferably 3.38.

According to exemplary embodiments, the bifunctional silicone monomer may further include a second bifunctional monomer represented by Formula 7 below.

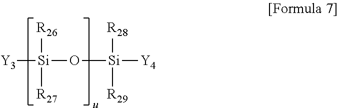

In Formula 7 above, R₂₆, R₂₇, R₂₈ and R₂₉ may be each independently hydrogen or an alkyl group having 1 to 3 carbon atoms, and preferably a methyl group.

u may be an integer from 1 to 100, preferably an integer from 1 to 20, or an integer from 3 to 15.

Y₃ and Y₄ may be each independently a substituent represented by Formula 8 below.

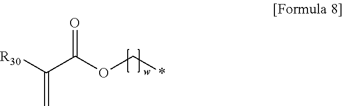

In Formula 8 above, * is a bond, and may be a site binding to silicon (Si) in Formula 7. R₃₀ may be hydrogen or a methyl group.

w may be an alkylene group having 1 to 5 carbon atoms, and preferably an alkylene group having 2 to 4 carbon atoms.

In some embodiments, the content of the first bifunctional monomer may be higher than the content of the second bifunctional monomer. Accordingly, the viscosity of the composition may be decreased while securing the mechanical properties and moisture resistance of the lens, and the heat resistance and flexibility of the lens may be improved.

According to exemplary embodiments, the content of the monofunctional silicone monomer may be higher than the content of the bifunctional silicone monomer. Since the monofunctional silicone monomer is included in a relatively excessive amount compared to the bifunctional silicone monomer, overpolymerization of the lens may be prevented and structural stability may be ensured upon hydration. Accordingly, the lens may have a low expansion rate, and structural characteristics may be improved by preventing misalignment and distortion of the lens in relation to the non-expandable module.

In some embodiments, the ratio of the content of the monofunctional silicone monomer to the content of the bifunctional silicone monomer may be 5 to 10, and preferably 5 to 9, or 6 to 8.5. Within the above range, overpolymerization and excessive cross-linking of the monomer blend may be prevented, and the mechanical properties and chemical stability of the polymer may be improved. Therefore, expansion or contraction of the lens due to hydration may be further suppressed, and change in the shape of the lens may be prevented.

In some embodiments, a total content of the monofunctional silicone monomer and the bifunctional silicone monomer may be 50 to 95% by weight (‘wt. %’) based on a total weight of the monomer blend, and preferably 75 to 85 wt. %.

In some embodiments, the content of the monofunctional silicone monomer may be 30 to 85 wt. % based on the total weight of the monomer blend within the above range.

In one embodiment, when the monofunctional silicone monomer includes both the first monofunctional monomer and the second monofunctional monomer, the content of the first monofunctional monomer may be 30 to 50 wt. % based on the total weight of the monomer blend, and preferably 35 to 45 wt. %. In addition, the content of the second monofunctional monomer may be 30 to 40 wt. % based on the total weight of the monomer blend.

Within the above range, the hydrophilicity of the monomer blend may be appropriately secured, and expansion and contraction of the lens upon hydration may be suppressed.

In some embodiments, the content of the bifunctional silicone monomer may be 5 to 15 wt. % based on the total weight of the monomer blend.

In one embodiment, when the bifunctional silicone monomer includes both the first bifunctional monomer and the second bifunctional monomer, the content of the first bifunctional monomer may be 3 to 10 wt. % based on the total weight of the monomer blend, and preferably 4 to 9 wt. %. In addition, the content of the second bifunctional monomer may be 1 to 5 wt. % based on the total weight of the monomer blend.

According to exemplary embodiments, an expansion rate of the monomer blend may be 6% or less. The expansion rate may be calculated by Equation 2 below.

(Db-Da/Da)×100% [Equation 2]

In Equation 2, Da may be a diameter of a polymer formed by polymerizing the monomer blend. For example, the monomer blend may be thermally polymerized or photo-polymerized to form a polymer, and a diameter of the formed polymer may be measured to calculate Da.

In one embodiment, thermal polymerization may be performed at a temperature of 95 to 150° C. for 45 to 75 minutes. The thermal polymerization process may be performed using a thermal oven (convection oven).

In one embodiment, photo-polymerization may be performed at a wavelength of 180 to 450 nm with an exposure amount per area of 1 to 20 mW/cm² for 5 to 30 minutes. The photo-polymerization process may be performed using a UV lamp such as an ultra-high pressure mercury lamp.

Db may be a diameter of the polymer measured after hydration thereof. For example, Db may be a diameter of the completely hydrated polymer. The hydration process may be performed using deionized water.

Since the monomer blend has an expansion ratio of 6% or less, the structural stability of the polymer, for example, the lens, may be improved. Thus, a relative difference in the expansion rate between the monomer blend and the non-expandable module may be reduced, and distortion and cracks, which may occur in a region where the non-expandable module and the polymer of the monomer blend are in contact with each other, may be prevented.

In some embodiments, the expansion rate of the monomer blend may be 5% or less, preferably 4% or less, 3% or less, 2% or less, 1% or less, or 0.5% or less.

Within the above range, a lens with improved stress intensity and elasticity while having high heat resistance and flexibility may be provided.

According to exemplary embodiments, the monomer blend may further include at least one of a hydrophilic monomer, a UV blocker (sunscreen), an initiator and a cross-linker, and may further include a solvent.

The hydrophilic monomer may further improve the hydrophilicity of the smart lenses. For example, the hydrophilic monomer may include hydroxyethyl methacylate (HEMA), vinyl pyrrolidone (N-vinyl-2-pyrrolidone, NVP), poly vinyl pyrrolidone (PVP), methylmethacrylate (MMA), ethylmethacrylate (EMA), glycerol methacylate (GMA), N, N-dimethyl acrylamide (DMA) and the like. Preferably, the hydrophilic monomer may include HEMA and/or NVP, and more preferably includes HEMA and NVP together.

In one embodiment, the content of the hydrophilic monomer may be 4 to 25 wt. % based on the total weight of the monomer blend, and preferably 10 to 20 wt. %. Within the above range, the hydrophilicity of the smart lens may be improved while suppressing an increase in degree of expansion of the smart lens upon hydration thereof.

In one embodiment, when the hydrophilic monomer includes HEMA and NVP together, the content of HEMA may be 4 to 10 wt. %, and the content of NVP may be 5 to 15 wt. % based on the total weight of the monomer blend. Within the above range, the hydrophilicity of the lens may be appropriately implemented, and distortion and indention due to the expansion may be prevented.

The UV blocker may improve the light resistance of the lens, and enhance life-span and storage stability thereof. For example, the UV blocker agent may include 2-(4-benzoyl-3-hydroxyphenoxy)ethyl acrylate.

In one embodiment, the content of the UV blocker may be 0.1 to 5 wt. % based on the total weight of the monomer blend, and preferably 0.5 to 2 wt. %.

The cross-linker may further improve the degree of cross-linking of the monomer blend. In one embodiment, the cross-linker may have a molecular weight lower than that of the monofunctional silicone monomer and the bifunctional silicone monomer.

For example, the cross-linker may include allylmethacrylate, polyalkylene glycol dimethacrylate, divinylether, methylene bismethacrylamide and the like. Preferably, the cross-linker includes tetraethylene glycol dimethacrylate.

In one embodiment, the content of the cross-linker may be 0.01 to 1 wt. % based on the total weight of the monomer blend, and preferably 0.05 to 0.5 wt. %.

The initiator may be used without particular limitation as long as it can induce a cross-linking reaction or polymerization reaction of the monomer blend, for example, through an exposure or heating process.

For example, as the initiator, a peroxide compound, an acetophenone compound, a benzophenone compound, a benzoin compound, a triazine compound, a biimidazole compound, an oxime ester compound, and the like may be used, and preferably the peroxide compound is used.

For example, the initiator may include tert-butylperoxyacetate, di(2-ethylhexyl) peroxydicarbonate, tert-amylperoxyneodecanoate or tert-butyl peroxyneodecanoate, etc. These may be used alone or in combination of two or more thereof.

In some embodiments, the content of the initiator may be 0.1 to 5 wt. % based on the total weight of the monomer blend, preferably 0.5 wt. %, to 3 and more preferably 0.8 to 2 wt. %.

In some embodiments, the smart lens composition may include a solvent. The solvent may include an organic solvent that sufficiently dissolves the above-described monomer blend and does not cause precipitation. The solvent may include propylene glycol monomethyl ether (PGME) and/or propylene glycol monomethyl ether acetate (PGMEA), etc. The solvent may be included as a balance except for other components of the composition.

According to exemplary embodiments, the monomer blend may have a viscosity of 38 to 40 cP at room temperature (25° C.). Within the above range, workability of the smart lens composition may be improved, and uniform lenses may be manufactured. Preferably, the monomer blend has a viscosity of 39 to 40 cP, for example, 39.17 cP at room temperature.

According to exemplary embodiments, the non-expandable module may include electronic elements such as a sensor, an antenna, a chip, a thin film battery, a thin film camera and a drug release device.

The non-expandable module may be selected as an appropriate device depending on the purpose of use. For example, the smart lens may receive signals from an outside and provide them to the user. Alternatively, the smart lens may detect clinical information, health, and biometric changes of a user through information acquired from the user. Alternatively, the smart lens may implement augmented reality through the electronic elements inserted therein.

In one embodiment, the non-expandable module may be impregnated into the above-described monomer blend. For example, the smart lens composition may include the monomer blend, and the non-expandable module impregnated into the monomer blend.

### <Smart Lens>

The smart lens according to exemplary embodiments may be manufactured from the above-described smart lens composition.

For example, after injecting the above-described smart lens composition into a mold, an exposure or heating process may be performed thereon to polymerize the monomer blend. In one embodiment, the monomer blend may be thermally polymerized.

For example, the heating process may be performed at a temperature of 95 to 150° C., and preferably is performed at a temperature of 110 to 135° C. In addition, the heating process may be performed for 30 to 80 minutes, and may be performed for 45 to 75 minutes, or 55 to 70 minutes. In this case, the cross-link density and polymerization uniformity of the lens may be improved.

For example, the exposure process may be performed at room temperature and at a wavelength of 180 to 450 nm with an exposure amount per area of 1 to 20 mW/cm² for 5 to 30 minutes

In one embodiment, the monomer blend impregnated with the non-expandable module may be directly injected into the mold. In one embodiment, the non-expandable module may be placed in a mold for manufacturing a smart lens, and the monomer blend may be injected into the mold.

After polymerizing the smart lens composition, the polymer may be separated from the mold to obtain a smart lens. In one embodiment, the smart lens may be a smart contact lens.

In some embodiments, the smart lens may have a swelling factor of 1.0 to 1.05. The swelling factor may be calculated by Equation 1 below.

$$Swelling factor = Dw / Dd \qquad [ Equation 1 ]$$

In Equation 1, Dd is a diameter of a lens obtained by polymerizing the smart lens composition. For example, Dd may be a value measured in a dry state immediately after separating the lens polymerized from the smart lens composition from the mold.

Dw is a diameter of the lens measured in a state where the obtained lens is completely hydrated. For example, Dw may be a value measured after the separated lens is washed and completely hydrated. Deionized water may be used for hydration.

In one embodiment, the diameter of the lens may be measured using a JCF contact lens size analyzer.

For example, if the swelling factor of the smart lens exceeds 1.05, the indention and distortion of the lens may be increased due to the expansion caused by hydration. For example, if the swelling factor of the smart lens is less than 1.0, the lens may be distorted due to contraction of the lens, and stability may be deteriorated.

In one embodiment, the swelling factor of the smart lens may be 1.0 to 1.02. Within the above range, expansion or contraction of the lens due to hydration may be reduced, thus to improve the structural stability and storage properties of the lens.

Therefore, it is possible to prevent indention due to a difference in expansion properties between the polymer of the monomer blend and the non-expandable module. Accordingly, for example, when the smart lens is used as a contact lens, adhesion of the lens to the cornea of the eye may be enhanced, thereby improving the optical performance of the lens and the performance of the module.

For example, if the adhesion between the cornea of the eye and the smart lens is deteriorated as the shape of the lens changes, the wearer's view may be obstructed due to an empty space between the lens and the cornea. In addition, a radius of curvature of the lens may be distorted, such that the desired power of the lens may not be implemented. In addition, contact between the module and the user may be reduced, such that, for example, in the case of a module for diagnosis, the accuracy of diagnosis may be decreased.

The smart lens manufactured from the above-described smart lens composition has a low variation in the expansion rate, and may have high mechanical properties and stability. Accordingly, various functions according to the optical function of the lens and module may be appropriately implemented.

Hereinafter, experimental examples including specific examples and comparative examples are proposed to facilitate understanding of the present invention. However, the following examples are only given for illustrating the present invention and those skilled in the art will obviously understand that various alterations and modifications are possible within the scope and spirit of the present invention. Such alterations and modifications are duly included in the appended claims.

### Examples and Comparative Examples

### Example 1

40 parts by weight (‘wt. parts’) of MF-1000 (α-methacryloyloxy ethyliminocarboxyethyloxypropyl-poly(dimethylsiloxy)-butyldimethylsilane) as a first monofunctional monomer, and 35 wt. parts of SiGMA (3-methacryloxy-2-(hydroxypropyloxy) propylbis(trimethylsiloxy)methylsilane) as a second monofunctional monomer were mixed, and then 7 wt. parts of DF-2 (methacryloyloxyethyliminocarboxypropyl terminated polydimethylsiloxane) as a first bifunctional monomer, and 5 wt. parts of DMS-R22 (methacryloxypropyl terminated polydimethylsiloxane) as a second bifunctional monomer were mixed.

Thereafter, 4 wt. parts of 2-hydroxyethyl methacrylate (HEMA), and 8 wt. parts of N-vinyl pyrrolidone (NVP) as hydrophilic acrylate monomers were mixed. Then, 0.1 wt. part of tetraethylene glycol dimethagrylate (TEGDMA) as a cross-linker and 1 wt. part of 2-(4-benzoyl-3-hydroxyphenoxy)ethyl acrylate (UV 416) as a UV blocker, and 2 wt. parts of Luperox 10 (tertiary-butyl peroxyneodecanoate) as an initiator were added thereto and stirred for 30 minutes to prepare a mixture.

A module was placed in a female mold for cast molding, and the prepared mixture was injected therein so that the module was submerged in the mixture. A male mold was assembled to the female mold. Subsequently, the assembled mold was put into a thermal oven and polymerized, and then the molds were separated from each other to obtain a lens. The temperature of the thermal oven was set at 110 to 135° C., and a polymerization reaction was performed for 55 to 70 minutes.

A size of the obtained lens was measured in the first dry state using an Optimec model JCF contact lens dimension analyzer. Next, the lens was completely hydrated in deionized water, and then the size of the completely hydrated lens was measured using the Optimek model JCF contact lens dimension analyzer to calculate the swelling factor of Equation 1 above.

A lens was manufactured in the same manner except that the module was excluded when manufacturing the lens. Thereafter, the size Da of the lens was measured, the lens was completely hydrated in deionized water, and the size Db of the hydrated lens was measured to calculate the expansion rate of Equation 2 above.

### Example 2

40 wt. parts of MF-1000, 34 wt. parts of SiGMA, 5 wt. parts of DF-2, 5 wt. parts of DMS-R22, 4 wt. parts of HEMA and 8 wt. parts of NVP were mixed. Then, 0.1 wt. parts of TEGDMA as a cross-linker, 1 wt. part of UV416 as a UV blocker, and 2 wt. parts of Luperox 10 as an initiator were added thereto and stirred for 30 minutes to prepare a mixture.

Thereafter, a lens was manufactured in the same manner as in Example 1, and the swelling factor and expansion rate of the lens were calculated.

### Example 3

40 wt. parts of MF-1000, 35 wt. parts of SiGMA, 5 wt. parts of DF-2, and 5 wt. parts of DMS-R22 were mixed, and then 4 wt. parts of HEMA, and 8 wt. parts of NVP were mixed. Then, 0.1 wt. parts of TEGDMA as a cross-linker, 1 wt. part of UV416 as a UV blocker, and 2 wt. parts of Luperox 10 as an initiator were added thereto and stirred for 30 minutes to prepare a mixture.

Thereafter, a lens was manufactured in the same manner as in Example 1, and the swelling factor and expansion rate of the lens were calculated.

### Example 4

40 wt. parts of MF-1000, 35 wt. parts of SiGMA, 4 wt. parts of DF-2, and 5 wt. parts of DMS-R22 were mixed, and then 4 wt. parts of HEMA, 9 wt. parts of NVP, and 0.9 wt. parts of PVP were mixed. Then, 0.1 wt. parts of TEGDMA as a cross-linker, 1 wt. part of UV416 as a UV blocker, and 1 wt. part of Luperox 10 as an initiator were added thereto and stirred for 30 minutes to prepare a mixture.

Thereafter, a lens was manufactured in the same manner as in Example 1, and the swelling factor and expansion rate of the lens were calculated.

### Example 5

35 wt. parts of MF-1000, 35 wt. parts of SiGMA, 8 wt. parts of DF-2, and 5 wt. parts of DMS-R22 were mixed, and then 5 wt. parts of HEMA, 10 wt. parts of NVP, and 1.0 wt. parts of PVP were mixed. Then, 0.1 wt. parts of TEGDMA as a cross-linker, 1 wt. part of UV416 as a UV blocker, and 1 wt. part of Luperox 10 as an initiator were added thereto and stirred for 30 minutes to prepare a mixture.

Thereafter, a lens was manufactured in the same manner as in Example 1, and the swelling factor and expansion rate of the lens were calculated.

### Example 6

37 wt. parts of MF-1000, 33 wt. parts of SiGMA, 4 wt. parts of DF-2, and 4 wt. parts of DMS-R22 were mixed, and then 7 wt. parts of HEMA, 13 wt. parts of NVP, and 1.3 wt. parts of PVP were mixed. Then, 1 wt. part of UV416 as a UV blocker, and 1 wt. part of Luperox 10 as an initiator were added thereto and stirred for 30 minutes to prepare a mixture.

Thereafter, a lens was manufactured in the same manner as in Example 1, and the swelling factor and expansion rate of the lens were calculated.

### Example 7

35 wt. parts of MF-1000, 35 wt. parts of SiGMA, 0 wt. parts of DF-2, 5 wt. parts of DMS-R22, 7 wt. parts of HEMA, 13 wt. parts of NVP, and 1.3 wt. parts of PVP were mixed. Then, 1 wt. part of UV416 as a UV blocker, and 1 wt. part of Luperox 10 as an initiator were added thereto and stirred for 30 minutes to prepare a mixture.

Thereafter, a lens was manufactured in the same manner as in Example 1, and the swelling factor and expansion rate of the lens were calculated.

### Example 8

35 wt. parts of MF-1000, 33 wt. parts of SiGMA, 8 wt. parts of DF-2, 0 wt. parts of DMS-R22, 7 wt. parts of HEMA, 15 wt. parts of NVP, and 1.5 wt. parts of PVP were mixed. Then, 1 wt. part of UV416 as a UV blocker, and 1 wt. part of Luperox 10 as an initiator were added thereto and stirred for 30 minutes to prepare a mixture.

Thereafter, a lens was manufactured in the same manner as in Example 1, and the swelling factor and expansion rate of the lens were calculated.

### Example 9

35 wt. parts of MF-1000, 31 wt. parts of SiGMA, 10 wt. parts of DF-2, 0 wt. parts of DMS-R22, 7 wt. parts of HEMA, 15 wt. parts of NVP, and 1.5 wt. parts of PVP were mixed. Then, 1 wt. part of UV416 as a UV blocker, and 1 wt. part of Luperox 10 as an initiator were added thereto and stirred for 30 minutes to prepare a mixture.

Thereafter, a lens was manufactured in the same manner as in Example 1, and the swelling factor and expansion rate of the lens were calculated.

### Comparative Example 1

A mixture was prepared in the same manner as in Example 1, except that MF-1000 was added in the same amount instead of DF-2, and SiGMA was added in the same amount instead of DMS-R22.

A lens was manufactured by performing a polymerization reaction on the prepared mixture in the same manner as in Example 1. Since the lens of Comparative Example 1 was not separated from the mold, the swelling factor and expansion rate of the lens could not be measured.

### Comparative Example 2

A mixture was prepared in the same manner as in Example 1, except that DF-2 was added in the same amount instead of MF-1000, and DMS-R22 was added in the same amount instead of SiGMA.

A polymerization reaction was performed on the prepared mixture in the same manner as in Example 1. No polymer was formed from the mixture according to Comparative Example 2, and since the lens was not manufactured, the swelling factor and expansion rate could not be measured.

TABLE 1

| Item | Monofunctional | Bifunctional | Expansion | Swelling |
|---|---|---|---|---|
| (wt. parts) | monomer | monomer | rate (%) | factor |
| Example 1 | 75 | 12 | 0 | 1 |
| Example 2 | 74 | 10 | 0.5 | 1.005 |
| Example 3 | 75 | 10 | 0.99 | 1.01 |
| Example 4 | 75 | 9 | 1.48 | 1.015 |
| Example 5 | 70 | 13 | 1.96 | 1.02 |
| Example 6 | 70 | 8 | 2.91 | 1.03 |
| Example 7 | 70 | 5 | 3.85 | 1.04 |
| Example 8 | 68 | 8 | 4.76 | 1.05 |
| Example 9 | 66 | 10 | 5.66 | 1.06 |
| Comparative | 87 | 0 | — | — |
| Example 1 | | | | |
| Comparative | 0 | 87 | — | — |
| Example 2 | | | | |

### Experimental Example: Evaluation of Lens Distortion

The shapes of the lenses manufactured according to the examples and comparative examples were observed visually. To evaluate the shape of the lens, the shape before hydration and the shape after hydration were compared with each other, and the lens was observed visually to determine whether distortion of the lens has occurred. Standards for evaluation are as follows.

Evaluation results are shown in Table 2 below.

### <Standards for Evaluation>

⊚: Misalignment of the lens was not observed visually

∘: Misalignment in the long and short axes of the lens was observed visually

Δ: Indention was observed visually in some parts of the lens

x: Indention was observed visually throughout the lens, or the lens was not polymerized or separated from the mold

TABLE 2

| | Lens deviation |
|---|---|
| Item | evaluation |
| Example 1 | ⊚ |
| Example 2 | ⊚ |
| Example 3 | ⊚ |
| Example 4 | ⊚ |
| Example 5 | ⊚ |
| Example 6 | ◯ |
| Example 7 | ◯ |
| Example 8 | Δ |
| Example 9 | Δ |
| Comparative Example 1 | X |
| Comparative Example 2 | X |

Referring to Table 2 above, it can be seen that the polymers of the monomer blends according to the examples have an expansion rate of 6% or less, and the lenses manufactured from the monomer blends according to the examples have a swelling factor of 1 to 1.06, respectively. Further, it can be seen that the lenses manufactured according to the examples exhibit reduced distortion upon hydration.

FIGURE is photographs illustrating shapes of the lenses manufactured according to some examples.

Referring to FIGURE, in the case of Example 2 (SF 1.005) and Example 3 (SF 1.01), distortion of the lens was not observed visually. In the case of Example 6 (SF 1.03) and Example 8 (SF 1.05), misalignment in the major and minor axes of the lens with the major and minor axes of the lens measured in the first dry state was observed. However, in Examples 6 and 8, indention of the lens was not observed.

However, in the case of Comparative Example 1, due to the lack of the bifunctional monomer, an overpolymerization reaction has occurred in the monomer blend, and the lens and mold were not physically separated from each other.

In addition, in the case of Comparative Example 2, lack of the monofunctional monomer, due to the polymerization of the monomer blend did not occur sufficiently, and no polymer was formed from the monomer blend.

What is claimed is:

1. A smart lens composition comprising:
a non-expandable module; and
a monomer blend which comprises a monofunctional silicone monomer and a bifunctional silicone monomer,
wherein a content of the monofunctional silicone monomer is higher than a content of the bifunctional silicone monomer.

2. The smart lens composition according to claim 1, wherein the monofunctional silicone monomer comprises a first monofunctional monomer represented by Formula 1 below: 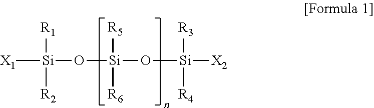
(in Formula 1 above,
R₁, R₂, R₃ and R₄ are each independently hydrogen or an alkyl group having 1 to 3 carbon atoms,
R₅ and R₆ are each independently an alkyl group having 1 to 3 carbon atoms,
n is an integer from 2 to 100,
X₁ is an alkyl group having 1 to 5 carbon atoms, an alkenyl group having 1 to 5 carbon atoms, or an alkynyl group having 1 to 5 carbon atoms, and
X₂ is a substituent represented by Formula 2 below) 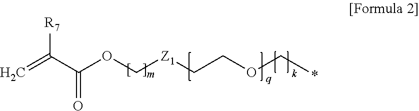
(in Formula 2, R₇ is hydrogen or a methyl group,
Z₁ is one selected from —NHCOO—, —NHCONH—, —OCONH—R₈—NHCOO—, —NHCONH—R₉—NHCONH— and —OCONH—R₁₀—NHCONH—,
R₈, R₉ and R₁₀ are each an alkylene group having 1 to 5 carbon atoms,
m is an integer from 1 to 5, q is 0 or an integer from 1 to 5, k is an integer from 1 to 10, and * is a bond).

3. The smart lens composition according to claim 2, wherein, n is 14 in Formula 1.

4. The smart lens composition according to claim 2, wherein the monofunctional silicone monomer further comprises a second monofunctional monomer represented by Formula 3 below: 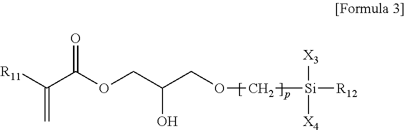
(in Formula 3, R₁₁ is hydrogen or a methyl group, R₁₂ is hydrogen or an alkyl group having 1 to 5 carbon atoms,
p is an integer from 1 to 5, and
X₃ and X₄ are each independently a substituent of Formula 4 below) 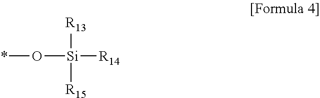
(in Formula 4, R₁₃, R₁₄ and R₁₅ are each independently hydrogen or an alkyl group having 1 to 3 carbon atoms, and * is a bond).

5. The smart lens composition according to claim 4, wherein a ratio of a content of the second monofunctional monomer to a content of the first monofunctional monomer is 0.5 to 2.

6. The smart lens composition according to claim 4, wherein the content of the first monofunctional monomer is higher than the content of the second monofunctional monomer.

7. The smart lens composition according to claim 2, wherein the bifunctional silicone monomer comprises a first bifunctional monomer represented by Formula 5 below: 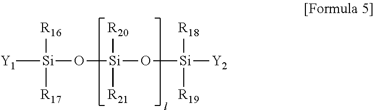
(in Formula 5, R₁₆, R₁₇, R₁₈ and R₁₉ are each independently hydrogen or an alkyl group having 1 to 3 carbon atoms,
R₂₀ and R₂₁ are each independently an alkyl group having 1 to 3 carbon atoms,
l is an integer from 2 to 100, and
Y₁ and Y₂ are each independently a substituent represented by Formula 6 below) 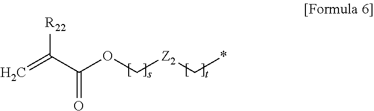
(in Formula 6, R₂₂ is hydrogen or a methyl group,
Z₂ is one selected from —NHCOO—, —NHCONH—, —OCONH—R₂₃—NHCOO—, —NHCONH—R₂₄—NHCONH— and —OCONH—R₂₅—NHCONH—,
R₂₃, R₂₄ and R₂₅ are each an alkylene group having 1 to 5 carbon atoms,
S is an integer from 1 to 5, t is an integer from 1 to 10, and * is a bond).

8. The smart lens composition according to claim 7, wherein, 1 is 14 in Formula 5.

9. The smart lens composition according to claim 7, wherein an atomic ratio (Si/C) of silicon atoms to carbon atoms in the first bifunctional monomer is 3 to 4.

10. The smart lens composition according to claim 7, wherein the bifunctional silicone monomer further comprises a second bifunctional monomer represented by Formula 7 below: 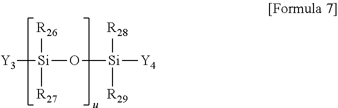
(in Formula 7, R₂₆, R₂₇, R₂₈ and R₂₉ are each independently hydrogen or an alkyl group having 1 to 3 carbon atoms, and u is an integer from 1 to 100, and
Y₃ and Y₄ are each independently a substituent represented by Formula 8 below) 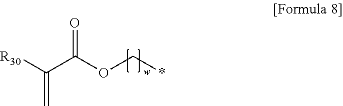
(in Formula 8, R₃₀ is hydrogen or a methyl group,
w is an alkylene group of 1 to 5, and * is a bond).

11. The smart lens composition according to claim 10, wherein a content of the first bifunctional monomer is greater than or equal to a content of the second bifunctional monomer.

12. The smart lens composition according to claim 1, wherein a ratio of the content of the monofunctional silicone monomer to the content of the bifunctional silicone monomer is 5 to 10.

13. The smart lens composition according to claim 1, wherein the monomer blend further comprises at least one of a hydrophilic monomer, a UV blocker, an initiator and a cross-linker.

14. The smart lens composition according to claim 13, wherein a total content of the monofunctional silicone monomer and the bifunctional silicone monomer is 50 to 95% by weight based on a total weight of the monomer blend.

15. The smart lens composition according to claim 14, wherein the content of the monofunctional silicone monomer is 30 to 85% by weight based on the total weight of the monomer blend, and
the content of the bifunctional silicone monomer is 5 to 15% by weight based on the total weight of the monomer blend.

16. The smart lens composition according to claim 1, wherein the monomer blend has a viscosity of 38 to 40 cP at room temperature (25° C.).

17. The smart lens composition according to claim 1, wherein the non-expandable module comprises at least one element selected from the group consisting of a sensor, an antenna, a chip, a thin film battery, a thin film camera and a drug release device.

18. A smart lens formed from the smart lens composition according to claim 1.

19. The smart lens according to claim 18,
wherein the smart lens a swelling factor of 1.0 to 1.05, which is calculated by Equation 1 below:
$$Swelling factor = Dw / Dd \qquad [ Equation 1 ]$$
(in Equation 1, Dd is a diameter of a lens obtained by polymerizing the smart lens composition, and Dw is a diameter of the lens measured in a state where the obtained lens is completely hydrated).

20. The smart lens according to claim 19, wherein the swelling factor is 1.0 to 1.02.
